(19) United States
(12) Patent Application Publication
(10) Pub. No.: US 2016/0109129 A1
(43) Pub. Date: Apr. 21, 2016

(54) HEAT SHIELD TILE FOR A HEAT SHIELD OF A COMBUSTION CHAMBER

(71) Applicant: SIEMENS AKTIENGESELLSCHAFT, München (DE)

(72) Inventor: Uwe Rettig, Ottobrunn (DE)

(73) Assignee: Siemens Aktiengesellschaft, Munich (DE)

(21) Appl. No.: 14/891,073

(22) PCT Filed: May 5, 2014
(86) PCT No.: PCT/EP2014/059065

§ 371 Date: Nov. 13, 2015

(30) Foreign Application Priority Data
May 21, 2013 (DE) 10 2013 209 284.9

(51) Int. Cl. F23R 3/00; B23P 19/04

(52) U.S. Cl. CPC F23R 3/007; B23P 19/04

(57) ABSTRACT

A heat shield tile detachably arranged on a bearing structure of a heat shield by at least one retaining element. The heat shield tile has a cold side facing the bearing structure, a hot side, arranged opposite the cold side and to which hot gases can be applied, and lateral surfaces that connect the cold side to the hot side. The heat shield tile reduces the amount of cooling air needed to flush the expansion gaps between the heat shield tiles of the heat shield. The heat shield tile has a main body and a number of segments. The segments are arranged adjacent to each other on the main body over the entire area of the main body such that expansion gaps are left. The segments are joined to the main body, such that at least the hot side of the heat shield tile is substantially formed by the segments.

### CROSS REFERENCE TO RELATED APPLICATIONS

This application is the US National Stage of International Application No. PCT/EP2014/059065 filed 5 May 2014, and claims the benefit thereof. The International Application claims the benefit of German Application No. DE 102013209284.9 filed 21 May 2013. All of the applications are incorporated by reference herein in their entirety.

### FIELD OF INVENTION

The invention relates to a heat shield tile and to a heat shield having at least one such heat shield tile. The invention also relates to a combustion chamber lined with such a heat shield and to a gas turbine and to a method for producing the heat shield tile.

### BACKGROUND OF INVENTION

In many technical applications, use is made of heat shields which have to withstand hot gases at 1000 to 1600 degrees Celsius. In particular, gas turbines, such as are used in current-generating power plants and in aircraft engines, have accordingly large surfaces, which are to be shielded by means of heat shields, within the combustion chambers. Due to the thermal expansion and because of the large dimensions of the combustion chambers, the heat shield must be composed of a multiplicity of individual, generally ceramic heat shield tiles (heat shield bricks) which are attached to a supporting structure spaced apart from one another with a sufficient gap. This gap provides the heat shield tiles, which can also be termed heat shield elements, with sufficient space for thermal expansion. However, since the gap also allows the hot combustion gases to come into direct contact with the metallic supporting structure and the retaining elements, it is possible as a countermeasure for cooling air to be injected through the gaps in the direction of the combustion chamber.

EP 1 557 611 A1 discloses a gas turbine combustion chamber which is lined internally with a heat shield. The heat shield comprises a supporting structure and a number of heat shield tiles which consist of a ceramic material and are releasably attached to the supporting structure by means of retaining elements. For the purpose of protecting the combustion chamber wall, the heat shield tiles are arranged in a surface-covering manner on the supporting structure while leaving expansion gaps, wherein each heat shield tile has a cold side oriented toward the supporting structure and, arranged on the opposite side from the cold side, a hot side which can be exposed to a hot medium. The cold side and the hot side are connected by side faces of the heat shield tile. The retaining elements holding the heat shield tile engage in each of two opposing side faces such that the retaining elements are exposed to the hot gases entering the expansion gaps. In order to avoid scaling of the retaining elements and of the supporting structure, cooling air is therefore guided into the expansion gaps from the direction of the supporting structure. However, the more cooling air is used for this purpose, the worse the exhaust gas values of the gas turbine and the lower the overall efficiency of the power generation. For that reason, EP 1 557 611 A1 proposes arranging sealing elements in the expansion gaps in order to reduce the required quantity of cooling air.

EP 1 715 249 A1 discloses a heat shield element for lining combustion chambers guiding hot gas, which element has a hot-side surface which is to be oriented toward the hot gas and is characterized in that the hot-side surface is provided with depressions and/or projections.

### SUMMARY OF INVENTION

The present invention has an object of indicating a heat shield tile as mentioned in the introduction, a heat shield having at least one such heat shield tile and a combustion chamber lined with the heat shield and a gas turbine with which the quantity of cooling air which is required for flushing the expansion gaps between the heat shield tiles can be particularly effectively reduced.

This object is achieved according to the invention with a heat shield tile of the type mentioned in the introduction, in that the heat shield tile comprises a base body and a number of segments, wherein the segments are arranged on the base body, adjoining one another, so as to cover the entire surface while leaving expansion gaps and are joined to the base body such that at least the hot side of the heat shield tile is formed essentially of the segments.

The heat shield tile constructed according to the invention makes it possible to increase the dimensions of the heat shield tile along the edges of the hot and cold sides, in comparison to conventional heat shield tiles. In the case of a heat shield having at least one such heat shield tile, this leads, in the region of the latter, to a reduction in the expansion gaps per unit of surface area, and thus to a reduction in the quantity of cooling air required overall.

According to the invention, the heat shield tile has a hybrid construction comprising at least one base body and the segments arranged thereon and joined therewith. The segmentation of the hottest parts of the hybrid structure permits a reduction in thermally induced stresses. The segments and the base body may for example have comparable dimensions perpendicular to the supporting structure. The base body is less exposed to the thermally induced stresses caused by the hot gases than are for example the segments, such that its base area can accordingly be made bigger. Since the base body and the segments are joined together, the segments can have, without limiting their dimensions and perpendicular to the supporting structure, a thickness required for the desired thermal barrier effect, wherein it is merely necessary to select a joining technology suitable for the weight of the segment in order to join the segment and base body. For example, the use of an adhesive joining technology is particularly suitable on account of the base areas of the segments being small as a consequence of the segmentation. For such an adhesive material bond, use is for example made of adhesives and cements which, after curing, consist essentially of inorganic components.

Joining together the heat shield tile from different structures also permits separate production of the base body and of the segments.

This has the further advantage that it is possible to optimize the materials and the production methods for the function of the structures to be joined together. It is thus possible for the base body for example to be made of a material that is more stable—albeit less resistant to high temperatures—than that of the segments. This makes it possible to further increase the dimensions of the heat shield tile along the edges of the cold and hot sides. A further advantage of the invention is that, on account of the larger dimensions of the heat shield tile, fewer retaining elements per unit of surface area are required overall.

One advantageous embodiment of the invention can provide that the segments are adhesively bonded to adhesive bonding regions of the base body.

The adhesive layer is exposed to lower temperatures than is the hot side of the heat shield tile. The adhesive can for example be Ceramabond 503 from Aremco. Further exemplary embodiments for the adhesive may be adhesive systems having a phosphatic or silicatic binder phase.

Adhesive bonding of large surfaces is technologically very demanding. In particular, ensuring an exact fit between the complementary faces, which is a precondition for an even thickness of the adhesive layer, is very onerous. Since the inventive construction of the heat shield tile provides for segmentation and thus reduction in the surfaces to be bonded with respect to a layered construction, the joining technology indicated according to the advantageous embodiment of the invention can be used particularly efficiently.

It can also be considered advantageous that the mechanical stability of the heat shield tile is ensured for the most part by the base body.

This makes it possible to dispense with unnecessary material requirements for the segments, such that material costs can be saved.

It can advantageously be further provided that the at least one retaining element can be arranged on the base body.

The retaining element is thus expediently attached to the base body, which is capable of withstanding greater mechanical loads.

According to a further advantageous embodiment of the invention, the base body can be made of a metallic material and/or a monolithic ceramic and/or a ceramic matrix composite and/or a high-temperature refractory ceramic.

The metal may for example be IN718 (trade name of Special Metals Corporation), MAR-M-247 or MAR-M-509 (trade names of Martin Marietta). The monolithic ceramic may for example be Si₃N₄, ZrO₂, mullite or SiC.

The fibers of the ceramic matrix composite may for example consist of Nextel 610, Nextel 720 (trade name of 3M), Al₂O₃, mullite or SiC.

The high-strength refractory ceramic can be made on the basis of Al₂O₃, mullite, corundum, SiC or zirconium.

It can further be advantageously provided that a high-temperature resistance and/or a thermal barrier property and/or a corrosion resistance of the heat shield tile is ensured essentially by means of the segments.

This makes it possible to dispense with unnecessary material requirements for the base body, such that material costs can be saved.

In order to produce the three named properties of the segments, these can themselves have a layered construction. This makes it possible to save further material costs.

For example, the segments can be made of a high-temperature ceramic or a high-temperature ceramic system. For example, the ceramic may be zirconium oxide with one or more stabilizers. According to a further exemplary embodiment of the configuration of the invention, the material of the segments can also be FGI material (Siemens).

A further advantageous configuration of the invention can provide that the connection surfaces between the segments and the base body are structured or roughened.

This makes the connection between the segments and the base body, in particular an adhesive connection, more secure.

Advantageously, the connection surfaces can have grooves and/or bumps.

These structures are particularly simple to produce and permit an advantageous enlargement of the adhesive bonding faces.

It can also be considered advantageous that the segments are, exclusively or in addition to a material-bonded connection, arranged on the base body in a force-fitting and/or form-fitting manner.

For applications which require very high reliability of the hybrid heat shield tile, and in which the loss of a segment cannot be tolerated, this configuration of the invention permits a particularly secure connection between the segment and the base body. The force-fitting connection can be realized for example by mutually engaging structures of the connection surfaces. For example, the adhesive bonding surfaces can have mutually engaging structures corresponding to a dovetail connection, wherein the attachment of a segment to such an adhesive bonding surface can be performed by means of an assembly movement parallel to the hot side.

One advantageous configuration of the invention can, in order to further secure the connection between the segment and the base body, provide at least one reinforcing element which connects a segment to the base body or a segment to an adjacent segment.

The reinforcing element can for example consist of monolithic ceramic, for example of Si₃N₄, Al₂O₃, SiC or ZrO₂. In order to attach the reinforcing element to the segment and to the base body, it is possible, for example when producing one of the components in the case of a ceramic material, for the reinforcing element to simply be cast concomitantly during the casting process of the component. In order to attach the component to the respective other component, the reinforcing element can for example be screwed and/or adhesively bonded into the other component. The reinforcing element thus secures, in a redundant manner, the connection between the two components in addition to an adhesively bonded connection which is for example provided.

A particularly secure and simple to manipulate attachment of the reinforcing element on the base body can provide that the base body has, for receiving the reinforcing element, a cutout which extends as far as the cold side. The reinforcing element arranged on a segment can in this context be designed such that it extends along the cutout in the base body essentially as far as the cold side of the heat shield tile, and is connected to the base body.

Advantageously, it is possible to provide at least one securing element which is arranged in the region of the cold side of the heat shield tile and is connected to at least one reinforcing element that extends essentially as far as the cold side. The reinforcing element extends along a cutout in the base body.

A securing ring, arranged from the cold side around an end region of the reinforcing element, can for example serve to secure the reinforcing element in the cutout. A further exemplary embodiment of a securing element can be a strip, for example made of metal, into one longitudinal side of which notches are introduced, corresponding to the separations between the reinforcing elements projecting out of the cutouts on the cold side, which surround the ends of a row of reinforcing elements. It is thus possible to attach an entire group of reinforcing elements to the base body by means of such a securing clip. The securing element may for example consist of X11, IN718 (trade name of Special Metals Corporation) or MAR-M-509 (trade name of Martin Marietta).

A further object of the invention is that of indicating a heat shield as mentioned in the introduction, with which the quantity of cooling air which is required for flushing the expansion gaps between the heat shield tiles can be particularly effectively reduced.

This object is achieved according to the invention with a heat shield of the type mentioned in the introduction, in that at least one heat shield tile is formed as claimed.

The inventive heat shield may comprise one or more heat shield tiles so formed. It is for example also possible for all of the heat shield tiles of the heat shield to be formed as claimed. In order to further increase the saving in terms of cooling air, it is possible to arrange seal materials such as wovens, foams or windings in the expansion gaps between the heat shield tiles.

A further object of the invention is that of indicating a combustion chamber lined with a heat shield as mentioned in the introduction and a gas turbine having such a combustion chamber, with which the quantity of cooling air which is required for flushing the expansion gaps between the heat shield tiles can be particularly effectively reduced.

This object is achieved with a combustion chamber and a gas turbine of the type mentioned in the introduction in that the heat shield is formed as claimed.

A further object of the invention is that of indicating a method for producing a heat shield tile of the type mentioned in the introduction, with which the quantity of cooling air which is required for flushing the expansion gaps between the heat shield tiles can be particularly effectively reduced.

This object is achieved with a method of the specified type in that, in order to construct the heat shield tile,—a base body and a number of segments are produced, and—the segments are arranged adjoining one another in a surface-covering manner on the base body while leaving expansion gaps, and are joined to the base body,—wherein the segments are arranged on the base body at least in the region of the hot side of the heat shield tile, such that the hot side of the heat shield tile is formed essentially by surface regions of the segments.

With regard to the advantages of the heat shield tile produced by means of the method, see the above remarks relating to the claims.

The segments and the base body may have partially common production steps. This is in particular the case if they are made of the same material. For example, the segments may be sawn out of a common piece of material. In addition, the sequence, indicated in the claim, of the method steps of producing the segments/base body and of arranging the segments on the base body does not necessarily correspond to a temporal sequence of the two method steps. The segments may for example grow on the base body by means of laser sintering methods. The joining of segments and base body does not necessarily presuppose, within the context of this invention, the prior separate existence of the components. All that is essential here is that, with the combination of the components used and the chosen joining technique, it is possible to achieve a separation in the functions of the components, such that the mechanical stability of the heat shield tile is ensured essentially by the base body and the thermal barrier property of the heat shield tile is ensured essentially by the segments. This is advantageously achieved by using the virtues of specialized materials.

It can advantageously be provided that the segments are attached to the base body by means of a material-bonded connection, in particular by means of an adhesive connection. The connection properties can be further improved by structuring the connection faces between the segments and the base body. The structuring can be effected during production of the base body and of the segments, or can be introduced into these subsequently.

It can also be considered advantageous for at least one reinforcing element to be arranged on a segment or the base body. When attaching the segment to the base body, the reinforcing element is attached to the respectively opposite component.

The reinforcing element reinforces the connection between the segment and the base body or serves to secure the attachment in that it runs between the segment and the adjacent segment. The reinforcing element effectively counteracts separation and loss of the segment in the event of failure of the primary connection method.

To that end, it can be advantageously provided that the reinforcing element is secured on the base body with a securing element.

Further expedient configurations and advantages of the invention form the subject matter of the description of exemplary embodiments of the invention, with reference to the figures of the drawing, wherein identical reference signs relate to functionally identical components.

### BRIEF DESCRIPTION OF THE DRAWINGS

In the figures:

FIG. 1 shows a plan view of an exemplary embodiment of a heat shield tile according to the invention, with a plurality of segments;

FIG. 2 shows a sectional representation through a heat shield tile according to FIG. 1;

FIG. 3 shows a plan view of a further exemplary embodiment of a heat shield tile according to the invention, with an alternative form of the segments;

FIG. 4 shows a plan view of a further alternative exemplary embodiment of a heat shield tile according to the invention, with a further alternative segmentation of the segments;

FIG. 5 shows a sectional representation through a segment according to the invention, according to a further exemplary embodiment having an additional mechanical reinforcing element for anchoring the segment on the base body;

FIG. 6 shows a sectional representation through a corresponding base body according to the invention having a complementary receiving opening for the mechanical reinforcing element of FIGS;

FIG. 7 shows the segment of FIG. 5 and the base body of FIG. 6 in the connected state;

FIG. 8 shows an alternative embodiment of a heat shield tile according to the invention, having an additional mechanical reinforcing element between the segment and the base body and additional structuring of the connection face in the adhesive bonding region;

FIG. 9 shows a sectional representation through an alternative embodiment of a heat shield tile according to the invention, having alternatively shaped additional mechanical reinforcing elements between the segments and the base body;

FIG. 10 shows a sectional representation through an alternative embodiment of a heat shield tile according to the invention, which provides, in contrast to the exemplary embodiment represented in FIG. 8, additional adhesive bonding of the mechanical reinforcing elements in the base body;

FIG. 11 shows a sectional representation through an alternative embodiment of a heat shield tile according to the invention, having alternatively shaped additional mechanical reinforcing elements between the segments and the base body, which is held in the supporting structure by adhesive bonding;

FIG. 12 shows a sectional representation through an alternative embodiment of a heat shield tile according to the invention, having an additional mechanical reinforcing element between adjacent segments;

FIG. 13 shows a plan view of an alternative embodiment of a heat shield tile according to the invention, having additional mechanical reinforcing elements between adjacent segments and between the segments and the base body;

FIG. 14 shows a plan view of an alternative embodiment of a heat shield tile according to the invention, having additional mechanical reinforcing elements between adjacent segments and between the segments and the base body, and with an alternative segmentation;

FIG. 15 shows a plan view of an alternative embodiment of a heat shield tile according to the invention, having additional mechanical reinforcing elements between adjacent segments and between the segments and the base body, and with an alternative segmentation;

FIG. 16 shows a sectional representation through an alternative embodiment of a heat shield tile according to the invention, having additional mechanical reinforcing elements between the segments and the base body, and having an additional metallic securing element;

FIG. 17 shows a plan view of the cold side of the heat shield tile of FIG. 16;

FIG. 18 shows a plan view of the cold side of an alternative embodiment of a heat shield tile according to the invention, having an alternative segmentation with respect to FIG. 17, and

FIG. 19 shows a schematic representation of a gas turbine according to the prior art, in longitudinal section.

### DETAILED DESCRIPTION OF INVENTION

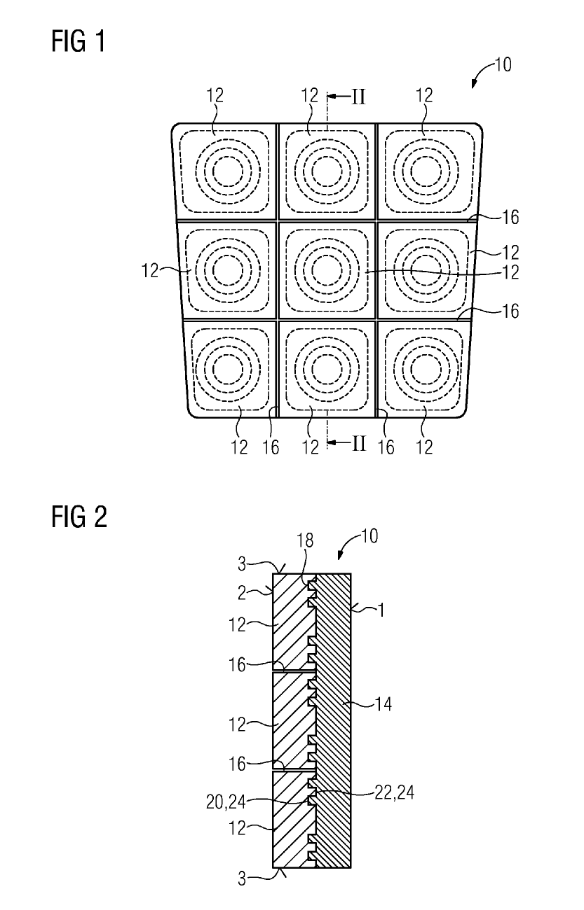

FIG. 1 shows a plan view of the hot side of an inventive heat shield tile 10, according to one exemplary embodiment. The heat shield tile 10 comprises a base body (arranged below the segments 12 in the plan view and thus not visible—corresponding to position 14 in FIG. 2) and a number of segments 12, which are arranged on the base body, adjoining one another, so as to cover the entire surface while leaving expansion gaps 16 and are joined to the base body such that at least the hot side of the heat shield tile 10 is formed essentially of the segments 12. In other words, the hot-side surface regions of the segments 12 essentially form the hot side of the heat shield tile 10.

The segments 12 need not necessarily have a rectangular circumferential contour as shown. What is essential is only that the segments 12 adjoin one another in a surface-covering manner while leaving expansion gaps 16, such that it is possible to cover the base body toward the hot side. The size of the segments can be adapted on one hand to a desired maximum thermal stress within a segment 12 and on the other hand to the type of connection between the segment 12 and the base body. Thus, for example in the case of an adhesive connection, the base surface of the segments 12 should advantageously not be chosen too large in order that it is possible to ensure an even thickness of the adhesive layer. On account of the segmentation, each segment 12 is exposed in operation to only relatively low thermal gradients in its expansion direction, such that the total expansion and thus the resulting thermal stresses within the individual segment 12 can be kept low.

The segments 12 serve as a thermal barrier and to shield the base body from hot gases. For that reason, according to the exemplary embodiment shown, the segments 12 are advantageously made of ceramics or ceramic systems which are resistant to high temperatures and to thermal shock and which have particularly low thermal conductivity. They protect regions situated behind them, in particular the base body. By means of the added segments 12, the base body is subjected to substantially lower thermal stresses and for this reason can have larger dimensions, along the represented outer edges of the heat shield tile 10, than conventional heat shield tiles. The base body serves for the mechanical integrity and stability of the heat shield tile 10.

In addition, on account of the thermal protection function of the segments 12, the base body can be made of materials which are optimized for their mechanical durability. Suitable for this are for example metals, monolithic ceramics, ceramic matrix composites or high-temperature refractory ceramics.

According to the exemplary embodiment represented, the segments 12 are adhesively bonded to adhesive bonding regions of the base body. The adhesion between the segments 12 and the base body can be increased if corresponding structure elements in the form of roughenings, grooves, bumps or the like are introduced into the respective connection faces of the segments and of the base body. This can be effected during production of the corresponding components or also subsequently, for example by mechanical or laser machining. FIG. 1 shows the profile of such structure elements by way of dashed lines.

FIG. 2 shows the heat shield tile 10 of FIG. 1 in a schematic sectional representation along the plane labeled II in FIG. 1.

The heat shield tile 10 can be arranged releasably, by means of retaining elements, on a supporting structure (not shown) of a heat shield, having a cold side 1 oriented toward the supporting structure and, arranged on the opposite side, a hot side 2 which can be exposed to hot gases, and side faces 3 connecting the cold side 1 and the hot side 2. The heat shield tile 10 has a hybrid construction with a base body 14 arranged on the cold side and the segments 12 arranged on the hot side and already represented in FIG. 1, wherein the thickness of the base body 14 and of the segments 12 perpendicular to the cold side, according to the exemplary embodiment shown, is essentially equal. The segments 12 are joined to the base body 14. The connection between the segments 12 and the base body 14 is ensured by means of an adhesive layer 18. On account of the relatively low areal extent of the individual segments 12, it is then possible, even under the extreme operating conditions of such a heat shield tile 10, to achieve a reliable adhesive bond. The adhesion between the segments 12 and the base body 14 can be further improved if corresponding structure elements 24 in the form of roughenings, grooves, bumps or the like are introduced into the respective connection faces 20 of the segments 12 and the adhesive bonding faces 22 of the base body 14. The adhesive bonding faces 22 of the base body can also be termed connection faces.

Although the adhesive layer 18 is shielded, by the segments 12, from the reaction gases to which the hot side 2 is exposed, use is advantageously made of an adhesive which, in the cured state, consists essentially of inorganic components, such that the durability of the connection remains long-term even under operational loads.

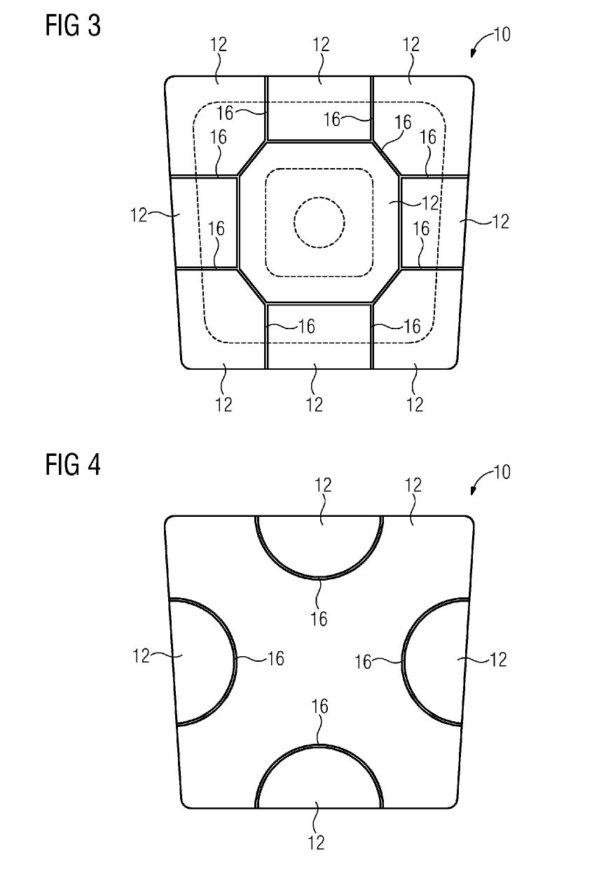

FIG. 3 and FIG. 4 show alternative exemplary embodiments of a heat shield tile 10 according to the invention. The exemplary embodiments differ from the exemplary embodiment shown in FIG. 1 in terms of the shape of the segments 12. The dashed lines in FIG. 3 correspond to an alternative profile of structure elements (position 24 in FIG. 2) which are introduced into the connection faces of the segments 12 and of the base body 14.

FIG. 5 shows a further alternative embodiment of a segment 12, in which there is embedded a reinforcing element 26.

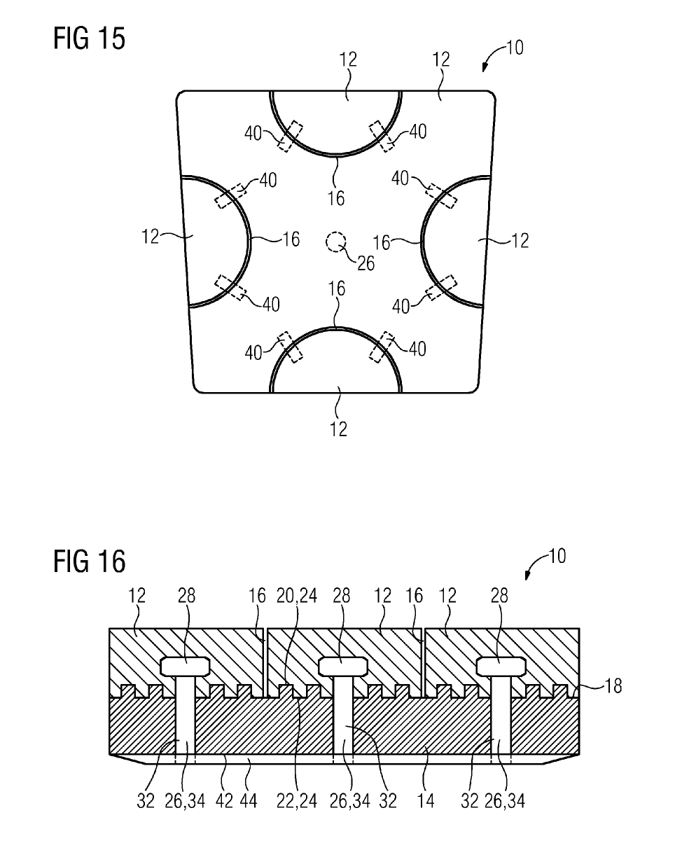

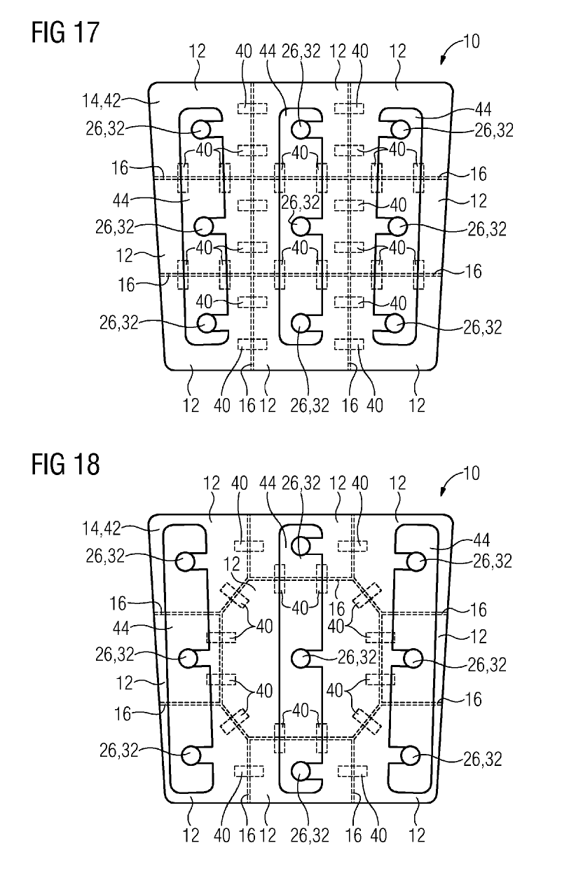

If particularly high demands are placed on the durability of the connection between the segment 12 and the base body 14, and loss of individual segments 12 in the event of localized failure of the adhesive layer 18 cannot be tolerated, it is possible, as shown in FIGS. 5 to 18, for the segments 12 to be additionally secured by means of mechanical reinforcing elements 26.

The reinforcing element 26 shown in FIG. 5 is held with a head region 28 in a corresponding cutout 30 of the segment 12 and partially projects out of the connection face 20 of the segment 12 with a shank 32. An annular slot 36 surrounds the end region of the shank 32.

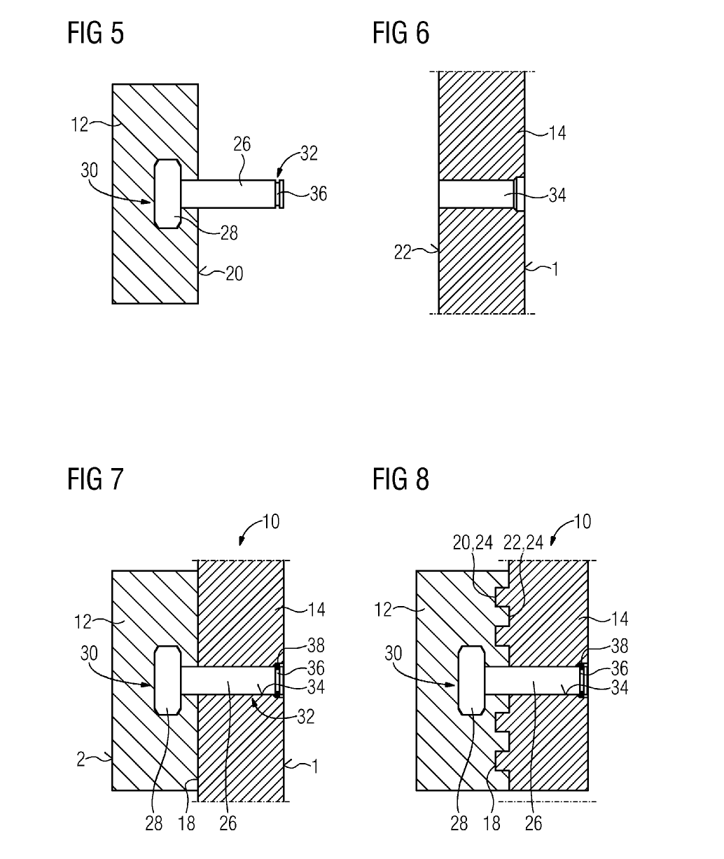

FIG. 6 shows an excerpt of the base body 14 according to an alternative exemplary embodiment. A cutout 34 runs through the base body, extending through the base body 14 from an adhesive bonding face 22 to the cold side 1. The cutout 34 is formed complementarily to the shank 32 of the reinforcing element 26 represented in FIG. 5.

FIG. 7 shows the segment 12 represented in FIG. 5, attached to the base body 14 represented in FIG. 6. For the purpose of attaching the segment 12, an adhesive layer 18 is arranged between the connection face 20 and the adhesive bonding face 22. The shank 32 of the reinforcing element 26 is arranged in the cutout 34 and extends essentially as far as the cold side 1. The shank 32 of the reinforcing element 26 is releasably attached in the cutout 34 by means of a metal securing ring 38 which is inserted into the annular slot 36.

In the assembled state of the heat shield tile 10, the securing ring 38 clamps the shank 32 of the reinforcing element 26 to the base body 14 and, in addition to the adhesive layer 18, provides an additional mechanical connection between the segment 12 and the base body 14. Here, too, the adhesion of the adhesive layer 18 can be improved by means of structure elements 24, as shown in FIG. 8.

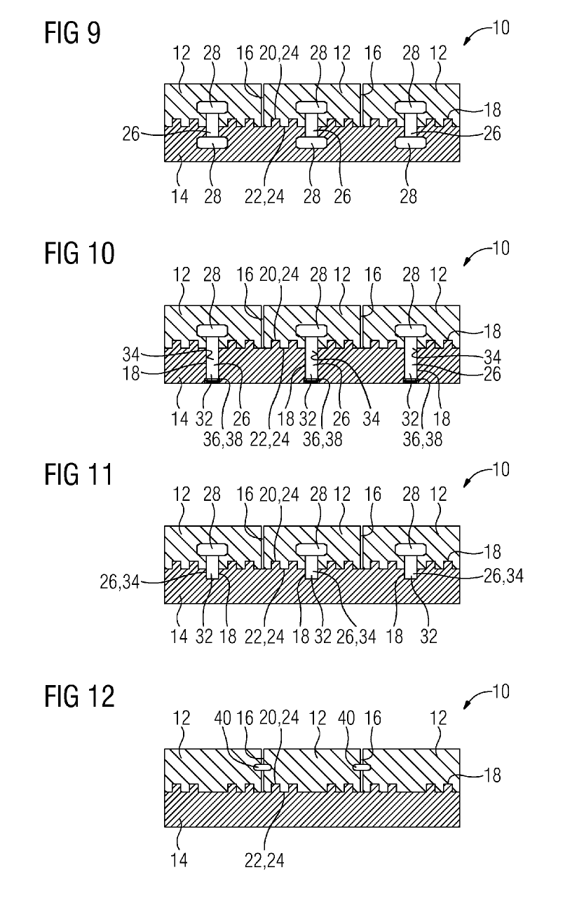

In addition to this exemplary embodiment of a heat shield tile 10 according to the invention, as shown in FIGS. 5 to 8, other shapes for the reinforcing element 26 are also conceivable. Two of these are represented in FIGS. 9 and 11. In that context, the reinforcing elements 26 shown in FIG. 9 have two head regions 28 and connect the segments 12 and the base body 14 by means of a form fit.

The embodiment of the reinforcing element 26 shown in FIG. 10 corresponds, in terms of shape, to that of FIGS. 5 to 8, wherein the shank 32 of the reinforcing element 26 is secured in the base body 14 by means of an additional adhesive layer 18 along the cutout 34. Such an additional adhesive layer 18 in the cutout 34 is also provided in the embodiment of FIG. 11, wherein the metal securing ring 38 is dispensed with and the cutouts 34 in the base body 14 take the form of blind holes.

As shown in FIG. 12, it is also possible for the segments 12 to be secured to one another by means of further reinforcing elements 40. As is the case for the reinforcing elements 26, these can be arranged in the segments 12 by form fitting or by adhesive bonding.

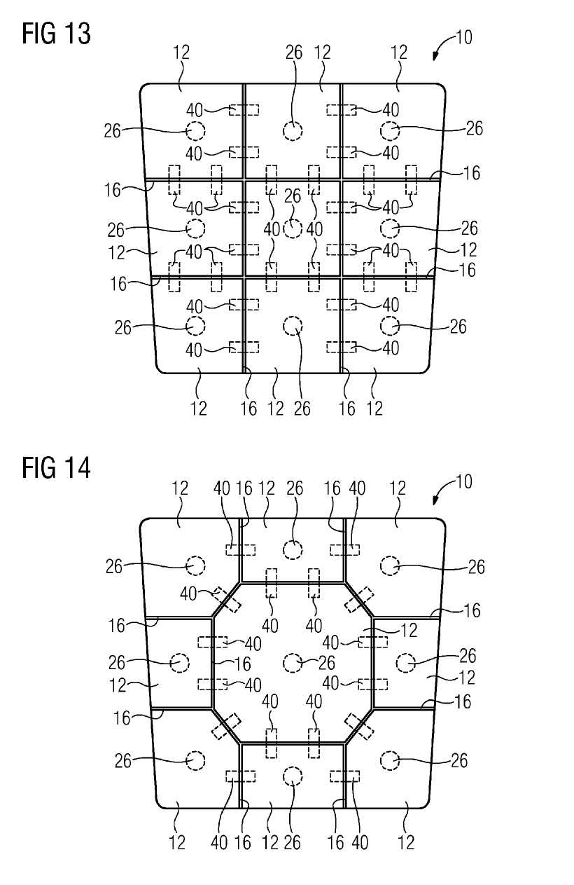

The reinforcing elements 26 and 40 can of course also be used simultaneously. FIGS. 13 to 15 show alternative embodiments of the heat shield tile 10 according to the invention, in plan view of the hot side. The exemplary embodiments show different shapes of the segments 12 and different arrangements of the reinforcing elements 26 and 40. Since the reinforcing elements 26 and 40 are arranged inside the heat shield tiles 10, their position is shown in FIGS. 13 to 15 with dashed lines.

As shown in FIGS. 16 to 18, the shank 34 of the reinforcing elements 26 can extend beyond the cold side of the base body 14 and can be used on that side of the base body 14 to anchor additional securing elements 44. These can for example be formed of metal and provide the heat shield tile 10 with additional mechanical stability.

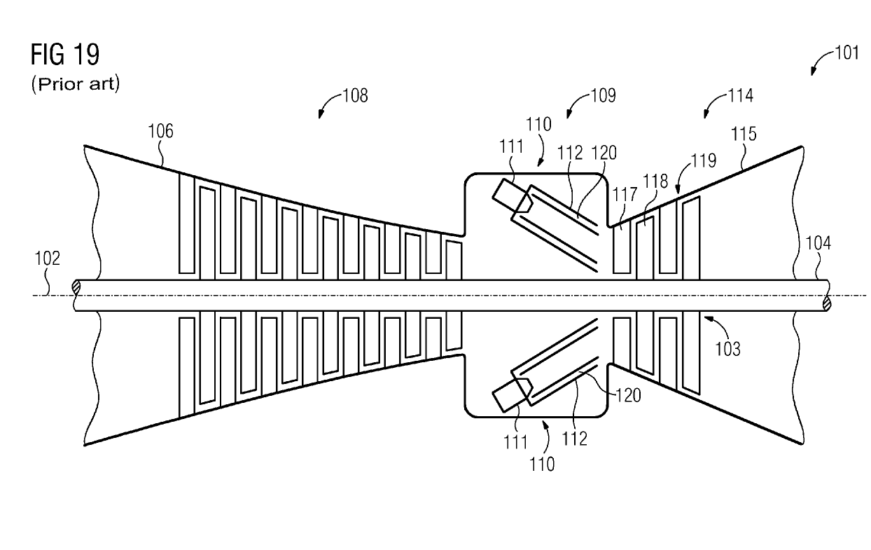

FIG. 19 shows a schematic sectional view of a gas turbine 101 according to the prior art. In the interior, the gas turbine 101 has a rotor 103 with a shaft 104 which is mounted such that it can rotate about an axis of rotation 102 and is also referred to as the turbine rotor. An intake housing 106, a compressor 108, a combustion system 109 having a number of combustion chambers 110, a turbine 114 and an exhaust gas casing 115 follow one another along the rotor 103. The combustion chambers 110 each comprise a burner arrangement 111 and a casing 112 which, for protection from hot gases, is lined with a heat shield 120.

The combustion system 109 corresponds to a, for example, annular hot gas duct. There, multiple series-connected turbine stages form the turbine 114. Each turbine stage is formed from blade rings. As seen in the direction of flow of a working medium, in the hot duct a row of guide vanes 117 is followed by a row of rotor blades 118. In that context, the guide vanes 117 are secured to an inner casing of a stator 119, whereas the rotor blades 118 of a row are fitted to the rotor 103 for example by means of a turbine disk. A generator (not shown) is for example coupled to the rotor 103.

While the gas turbine 101 is in operation, the compressor 108 sucks in air through the intake housing 106 and compresses it. The compressed air provided at the turbine-side end of the compressor 108 is passed to the combustion system 109, where it is mixed with a fuel in the region of the burner arrangement 111. The mixture is then combusted in the combustion system 109 with the aid of the burner arrangement 111, forming a working gas stream. From there, the working gas stream flows along the hot gas duct past the guide vanes 117 and the rotor blades 118. The working gas stream expands at the rotor blades 118, imparting its momentum, so that the rotor blades 118 drive the rotor 103 and the latter drives the generator (not shown) coupled to it.

1.-23. (canceled)

24. A heat shield tile which, by at least one retaining element, is adapted to be arranged releasably on a supporting structure of a heat shield, having
a cold side oriented toward the supporting structure and, arranged on the opposite side,
a hot side which can be exposed to hot gases, and
side faces connecting the cold side and the hot side,
wherein the heat shield tile comprises a base body and a number of segments,
wherein the segments are arranged on the base body, adjoining one another, so as to cover the entire surface while leaving expansion gaps and are joined to the base body such that at least the hot side of the heat shield tile is formed essentially of the segments,
wherein the segments are adhesively bonded to adhesive bonding regions of the base body.

25. The heat shield tile as claimed in claim 24,
wherein the mechanical stability of the heat shield tile is essentially ensured by the base body.

26. The heat shield tile as claimed claim 24,
wherein the at least one retaining element is adapted to be arranged on the base body.

27. The heat shield tile as claimed in claim 24,
wherein the base body is made of a metallic material and/or a monolithic ceramic and/or a ceramic matrix composite and/or a high-temperature refractory ceramic.

28. The heat shield tile as claimed in claim 24,
wherein high-temperature resistance of the heat shield tile is ensured essentially by means of the segments.

29. The heat shield tile as claimed in claim 24,
wherein the thermal barrier property of the heat shield tile is ensured essentially by means of the segments.

30. The heat shield tile as claimed in claim 24,
wherein corrosion resistance of the heat shield tile is ensured essentially by means of the segments.

31. The heat shield tile as claimed in claim 24,
wherein the segments themselves have a layered construction.

32. The heat shield tile as claimed in claim 24,
wherein the segments are made of a high-temperature ceramic or a high-temperature ceramic system.

33. The heat shield tile as claimed in claim 24,
wherein the connection surfaces between the segments and the base body are structured or roughened.

34. The heat shield tile as claimed in claim 33,
wherein the connection surfaces have grooves and/or bumps.

35. The heat shield tile as claimed in claim 24,
wherein the segments are, exclusively or in addition to a material-bonded connection, arranged on the base body in a force-fitting and/or form-fitting manner.

36. The heat shield tile as claimed in claim 24,
wherein at least one reinforcing element connects a segment and the base body or a segment with an adjacent segment.

37. The heat shield tile as claimed in claim 36,
wherein at least one reinforcing element is arranged on a segment and extends, along a cutout in the base body, essentially as far as the cold side of the heat shield tile.

38. The heat shield tile as claimed in claim 37,
wherein at least one securing element is arranged in the region of the cold side of the heat shield tile and is connected to at least one reinforcing element that extends essentially as far as the cold side.

39. A heat shield for a combustion chamber having
a supporting structure and a number of heat shield tiles which are held releasably on the supporting structure by means of retaining elements and each have a cold side oriented toward the supporting structure and, on an opposite side, a hot side which can be exposed to hot gases, wherein at least one heat shield tile is formed as claimed in claim 24.

40. A method for producing a heat shield tile which, by means of at least one retaining element, is adapted to be arranged releasably on a supporting structure of a heat shield, the heat shield tile having a cold side oriented toward the supporting structure and, arranged on the opposite side from the cold side, a hot side, and side faces connecting the cold side and the hot side, wherein, in order to construct the heat shield tile, the method comprises:
producing a base body and a number of segments are produced, and
arranging the segments adjoining one another in a surface-covering manner on the base body while leaving expansion gaps, and joining to the base body, wherein the segments are arranged on the base body at least in the region of the hot side of the heat shield tile, such that the hot side of the heat shield tile is formed essentially by surface regions of the segments,
arranging at least one reinforcing element on a segment or the base body and, when the segment is attached to the base body, attaching the reinforcing element to the respective opposite component.

41. The method for producing a heat shield tile of a heat shield as claimed in claim 40,
wherein the segments are attached on the base body in a material-bonded manner.

42. The method for producing a heat shield tile of a heat shield as claimed in claim 41,
wherein the arrangement of the reinforcing element on the base body is secured with a securing element.
